(19) United States
(12) Patent Application Publication
(10) Pub. No.: US 2025/0013347 A1
(43) Pub. Date: Jan. 9, 2025

(54) STORAGE MEDIUM, INFORMATION PROCESSING APPARATUS, AND INFORMATION PROCESSING METHOD

(71) Applicant: CANON KABUSHIKI KAISHA, Tokyo (JP)

(72) Inventor: HIROYUKI UCHIDA, Chiba (JP)

(21) Appl. No.: 18/762,392

(22) Filed: Jul. 2, 2024

(30) Foreign Application Priority Data
Jul. 5, 2023 (JP) 2023-110580

(51) Int. Cl. G06F 3/0482; G06F 3/0483

(52) U.S. Cl. CPC G06F 3/0482; G06F 3/0483

(57) ABSTRACT

A storage medium stores a program for causing a computer to perform: obtainment of information indicating a size of a size-changeable display region; and control based on the obtained information such that in a case where the display region has a first size, display items that correspond to a first number being plural of contents and are categorized into corresponding categories are displayed in areas corresponding to the categories, respectively, in the display region, and in a case where the display region has a second size smaller than the first size, operation items corresponding to the categories, respectively, are displayed in the display region and a display item corresponding to the content categorized into the category corresponding to a selected operation item is displayed without displaying a display item corresponding to the content categorized into the category corresponding to an unselected operation item.

### BACKGROUND OF THE INVENTION

### Field of the Invention

The present disclosure relates to a technique for displaying contents for a user having various purposes in conformity to a size of a display region.

### Description of the Related Art

Traditionally, a typical web browser has a function for displaying a web page with a layout suitable for various screen sizes, and there have been numerous web pages adopting this function. Moreover, many web pages include descriptions of contents that are sorted out in categories in order to provide a user with information tailored to various needs of the user. In addition, such a web page displays a list of the contents (such as topics) that belong to a category selected by the user.

Japanese Patent Laid-Open No. 2009-123020 (Patent Document 1) proposes a technique for displaying representative images by the categories out of multiple images that belong to the respective categories so that the user can easily understand pieces of information included in the respective categories.

However, a display method as in Patent Document 1 has a problem that the user cannot easily understand the contents of display in a case where a display region is small. In other words, viewability is deteriorated in a case where the images as the contents are not reduced in conformity to the display region, whereas viewability of the images is degraded in a case where the images are reduced in conformity to the display region.

### SUMMARY OF THE INVENTION

A storage medium according to an aspect of the present disclosure provides a non-transitory computer-readable storage medium storing a program for causing a computer to perform: obtainment of information indicating a size of a size-changeable display region; and control based on the obtained information such that, in a case where the size of the display region is a first size, display items that correspond to a first number being plural of contents and are categorized into a plurality of corresponding categories are displayed in a plurality of areas corresponding to the categories, respectively, in the display region, and, in a case where the size of the display region is a second size being smaller than the first size, a plurality of operation items corresponding to the plurality of categories, respectively, are displayed in the display region and a display item corresponding to the content categorized into the category corresponding to a selected one of the operation items is displayed without displaying a display item corresponding to the content categorized into the category corresponding to an unselected one of the operation items.

Further features of the present invention will become apparent from the following description of exemplary embodiments with reference to the attached drawings.

### BRIEF DESCRIPTION OF THE DRAWINGS

FIG. 1 is a diagram showing an example of a system configuration;

FIG. 2 is a sequence diagram showing an example of information obtainment processing by a web browser;

FIG. 3 is a diagram showing an example of a display screen (large layout) of a web page;

FIG. 4 is a diagram showing an example of the display screen (large layout, accordion open) of the web page;

FIG. 5 is a diagram showing an example of the display screen (medium layout) of the web page;

FIG. 6 is a diagram showing an example of the display screen (small layout) of the web page;

FIG. 7 is a diagram showing an example of the display screen (small layout, select another tab) of the web page;

FIG. 8 is a diagram showing an example of the display screen (details of topic) of the web page; and

FIG. 9 is a flowchart showing an example of screen display processing by the web browser.

### DESCRIPTION OF THE EMBODIMENTS

A preferred embodiment of the present disclosure will be described below in detail with reference to the accompanying drawings. It is to be noted that the following embodiment does not intend to restrict the present disclosure and that the entire combination of features described in the following embodiment is not always essential for a solution of the present disclosure. In the following description, the same configurations will be denoted by the same reference signs.

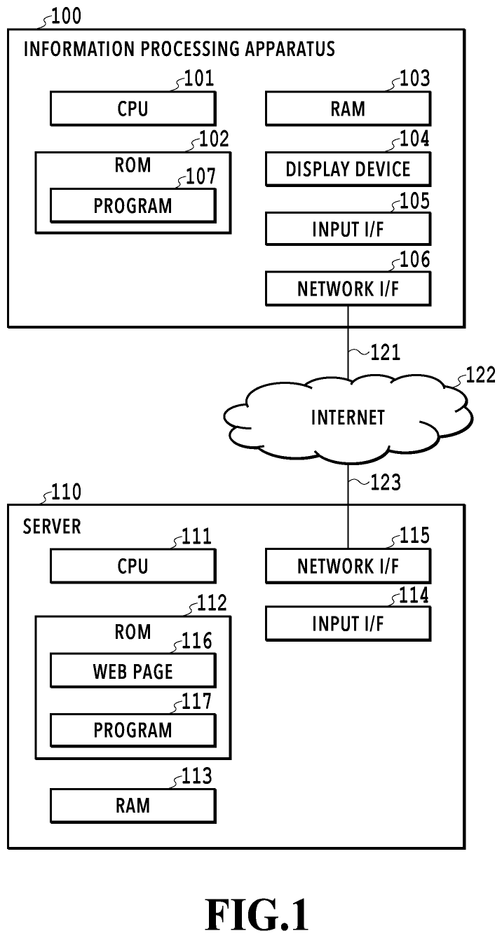

FIG. 1 is a diagram showing an example of a configuration of a system including an information processing apparatus 100 and a server 110. The configuration of the system according to the present embodiment will be described with reference to FIG. 1.

The information processing apparatus 100 includes a central processing unit (CPU) 101, a read only memory (ROM) 102, and a random access memory (RAM) 103. The information processing apparatus 100 includes a display device 104, an input interface (hereinafter referred to as an I/F (interface)) 105, and a network I/F 106. The CPU 101 is the central processing unit that reads a program 107 stored in the ROM 102 and executes the program 107. The ROM 102 is a nonvolatile storage medium that stores the program 107 such as a web browser 201 to be described later. The RAM 103 is a system memory for the CPU 101 and is used as a storage region such as a work area. The display device 104 is a device that displays image information outputted from the information processing apparatus 100. The input I/F 105 is an interface for inputting data and/or control information and the like to the information processing apparatus 100. The network I/F 106 is an interface for establishing connection between the information processing apparatus 100 and a network through a network connector 121. The information processing apparatus 100 can stablish connection to the Internet 122 through the network connector 121 by using an Ethernet (a registered trademark) cable and/or Wi-Fi (a registered trademark) and the like. The server 110 includes a CPU 111, a ROM 112, a RAM 113, an input I/F 114, and a network I/F 115. The CPU 111, the RAM 113, the input I/F 114, and the network I/F 115 have the same functions as the CPU 101, the RAM 103, the input I/F 105, and the network I/F 106, respectively, and explanations thereof will be omitted. The ROM 112 stores a web page 116, and a program 117 such as JaveScript and CSS, for example. Here, the program 117 includes a description concerning an operation of the web browser 201 in a case where the web browser 201 detects an operation on a screen displayed on the web browser 201 by the user, and a description concerning a layout of the web page corresponding to a size of a display region to be described later. In other words, the program 117 is a program for realizing a desired view of the web page 116. The web page 116 has URL of the program 117 corresponding to the web page 116. The server 110 can establish connection to the Internet 122 through a network connector 123. The information processing apparatus 100 and the server 110 can communicate with each other on the Internet 122.

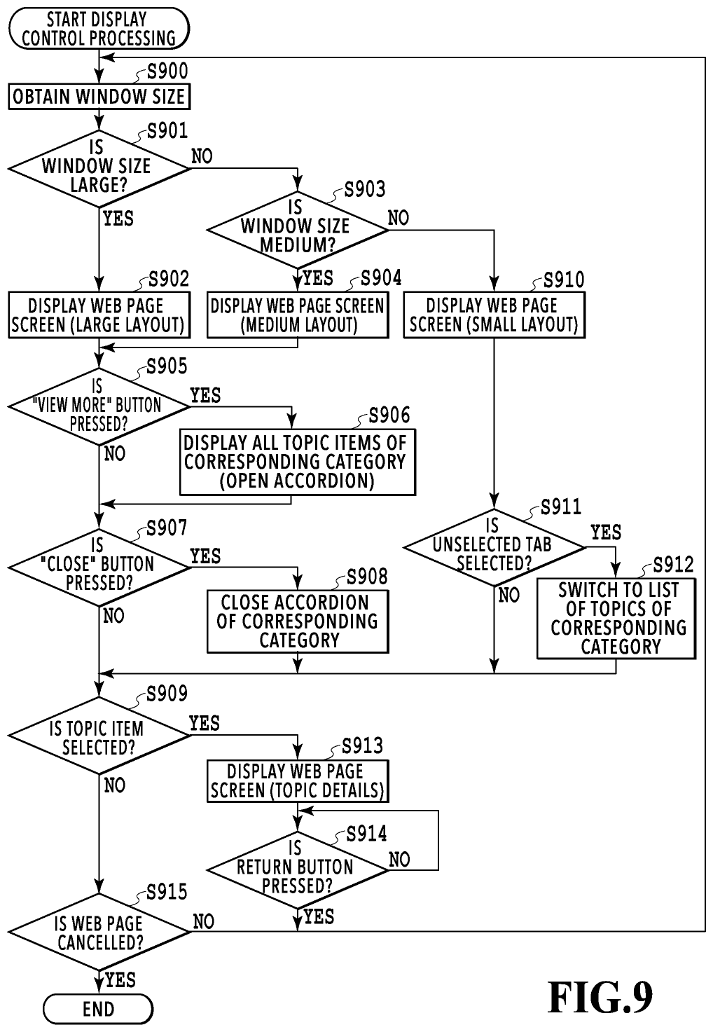

Now, the web browser 201 will be described. The web browser 201 is software for establishing connection to the server 110. In the meantime, the web browser 201 is a general browser for displaying web pages. In order to realize the desired view on the general browser, the server 110 stores the program 117 for the view. The user can browse a web page by using the web browser 201. The web browser 201 is implemented by the CPU 101 by causing the CPU 101 to read program codes of the web browser 201 from the ROM 102 and loading the program codes on the RAM 103. In order to display a desired page on the web browser 201, a storage region for retaining the web page 116 and the program 117 such as JavaScript and CSS is secured in the RAM 103. The web browser 201 can execute screen display processing shown in FIG. 9 to be described later by using the program retained in the RAM 103. The user can operate the web browser 201 through the input I/F 105. The RAM 103 secures a storage region for retaining information indicating the size of the display region (hereinafter referred to as a window size) of the web browser 201 in the display device 104 separately from the storage region necessary for displaying the web page on the web browser 201.

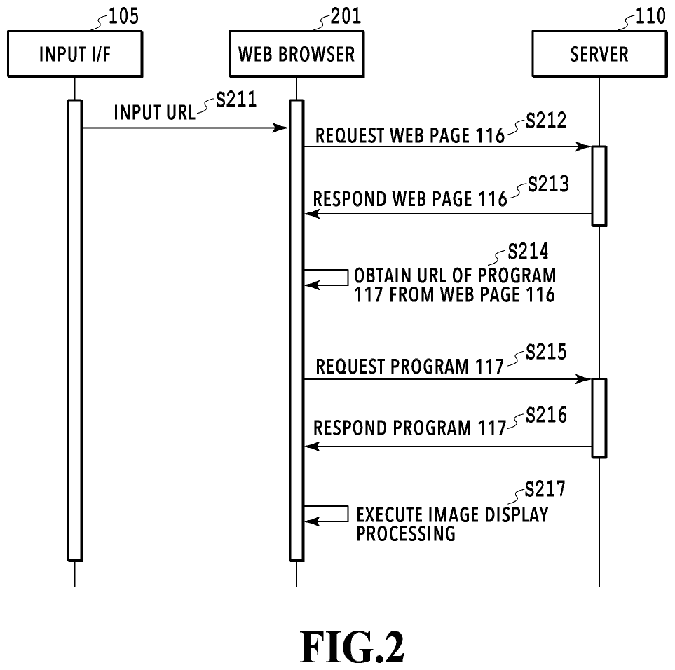

FIG. 2 is a sequence diagram showing an example of information obtainment processing to be executed by the web browser 201. A flow of the information obtainment processing executed by the web browser 201 will be described with reference to FIG. 2. In the following description of respective procedures, a sign “S” represents each procedure (each step) in FIG. 2.

In S211, the user inputs the URL corresponding to the web page 116 on the server 110 through the input I/F 105. In S212, the web browser 201 requests the web page 116 corresponding to the URL accepted in S211 from the server 110 through the network I/F 106. Subsequent to the acceptance of the request in S212, in S213, the server 110 responds the web page 116 to the web browser 201 through the network I/F 115. To be more precise, the web browser 201 receives the URL of the program 117 for executing processing in S217 to be described later, and contents data (such as image data) for displaying the web page 116 from the server 110. Subsequent to the reception of the response from the server 110 in S213, in S214, the web browser 201 obtains the URL of the program 117 from the web page 116.

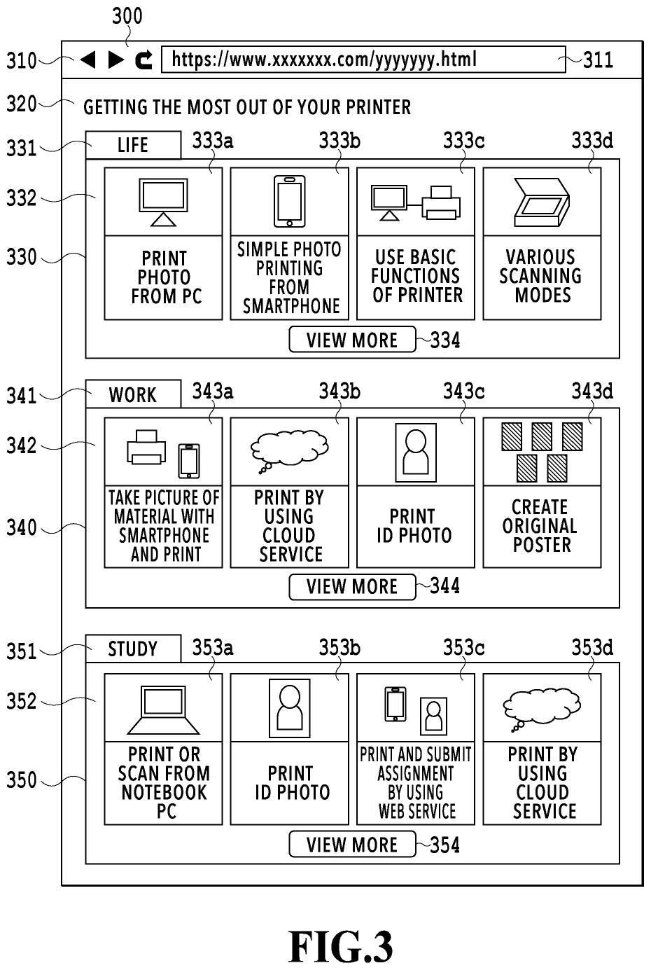

In S215, the web browser 201 requests the program 117 corresponding to the URL obtained in S214 from the server 110 through the network I/F 106. Subsequent to the acceptance of the request in S215, in S216, the server 110 responds the program 117 to the web browser 201 through the network I/F 115. As described above, in S213, the server 110 embeds the program (inclusive of the URL of the program 117 to be more precise) into the URL inputted by the user in S211 in advance, and responds to the web browser 201. Then, the web browser 201 obtains the program 117 through S215 and S216 in accordance with specifications of its own. Subsequent to the reception of the response from the server 110 in S216, in S217, the web browser 201 executes the screen display processing. In other words, the web browser 201 executes the screen display processing in accordance with the obtained program 117. As described above, the web browser 201 obtains the URL of the program 117 from the web page 116 responded from the server 110 in S213, and then obtains the program 117 through the S215 and S216. However, the present disclosure is not limited to this configuration. For example, the web browser 201 may obtain the program 117 in S213 and skip S215 and S216 thereafter. Display screens to be displayed on the web browser 201 based on the program 117 will be described with reference to FIGS. 3 to 8.

FIGS. 3 to 8 are diagrams showing examples of display screens of the web page to be displayed on the web browser 201. Transition of display screens of the web page will be described with reference to FIGS. 3 to 8.

FIG. 3 is a diagram showing an example of a display screen of a web page displayed on the web browser in a case where the window size is large (a first size). The web page displayed on the web browser will be described with reference to FIG. 3. In the following, the present embodiment will describe an example in which the contents displayed on the web page explain how to use a printer (a printing apparatus). However, the present disclosure is not limited to this example. For instance, the contents displayed on the web page may explain how to use a camera, a camera lens, a photo book, or any other products and apparatuses. Here, the large window size means that a value of the window size is equal to or above a first threshold. Determination of the window size will be explained with reference to FIG. 9. Meanwhile, the window size can be changed by an operation by a user. For example, the user can freely change the window size by dragging one of four corners or one of four sizes of the display region displayed on the web browser with a mouse and the like.

In FIG. 3, display items corresponding to four (a first number) contents categorized into each of category areas corresponding to multiple categories, respectively, as display screens of the web page according to an aspect of the present disclosure. In the following, the present embodiment will describe an example in which the first number is equal to four. However, the present disclosure is not limited to this configuration. For example, the first number may be any number equal to or above two. In other words, the first number may be any number for which the user can understand the multiple categories and the contents of the display items categorized into the corresponding categories. A display screen 300 in FIG. 3 includes a header portion 310 and a contents display portion 320. The header portion 310 includes an address bar 311 for displaying the URL corresponding to the web page 116. That is to say, the URL inputted by the user in S211 in FIG. 2 is displayed in the address bar 311. The contents display portion 320 includes a category display portion 330, a category display portion 340, and a category display portion 350.

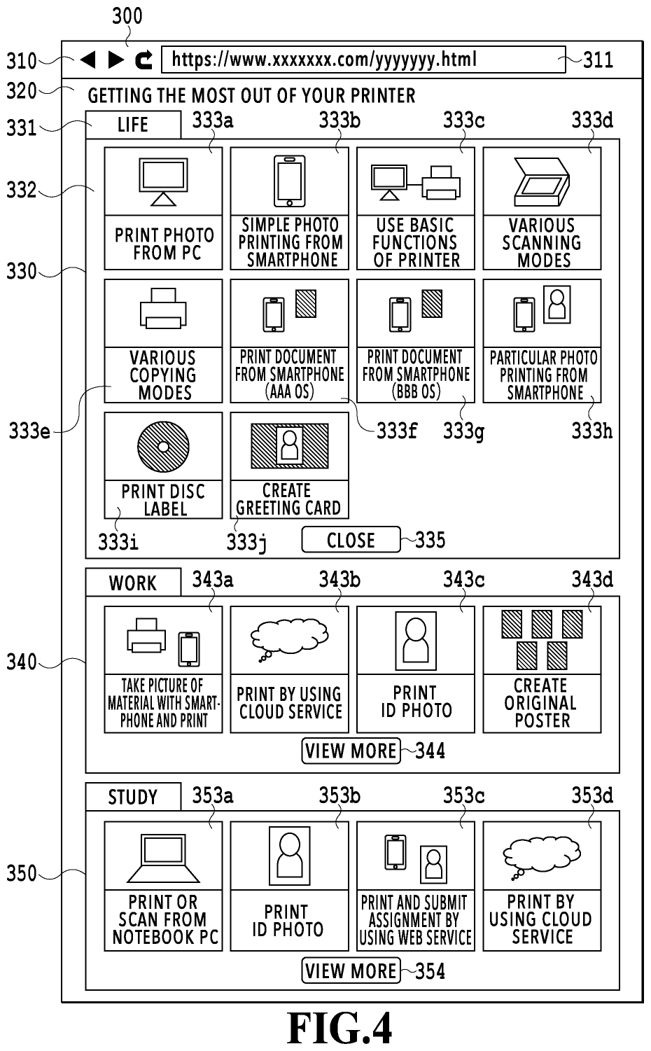

The category display portion 330 is formed from a set of a category name portion 331 and a topic display portion 332. The category name portion 331 is an area to display a name of a category. A name indicating the category into which the contents are categorized is displayed in the category name portion 331. In FIG. 3, a category “LIFE” is displayed in the category name portion 331. In the case where the user wants to access the contents concerning the “LIFE”, the user can search for topics concerning the category “LIFE” by viewing the display in the category name portion 331. The topic display portion 332 includes topic items 333a to 333d that belong to the category “LIFE”, and a “VIEW MORE” button 334 which is an operator. The topic items 333a to 333d are display items representing respective topics (contents) that belong to the category “LIFE”. In each topic item, an image (an illustration) representing the topic is displayed on an upper part thereof while a topic name is displayed on a lower part thereof. The user can search for a desired topic out of the illustrations and the names displayed in the topic items. Meanwhile, the topic items 333a to 333d are displayed on the topic display portion 332 as representative topic items that belong to the category “LIFE”. As a method of displaying the topic items 333a to 333d, the representative topic items may be displayed in descending order of the number of times the topic items have been selected by the user in the past. For example, the web browser may display the topic item having the largest statistical number of times selected by the user as the topic item 333a. Next, the web browser may display the topic item having the second largest statistical number of times selected by the user as the topic item 333b. In other words, the contents to be displayed as the representative topic items are selected in the descending order of the statistical number of times that the topic items are selected by the user. The category display portion 340 and the category display portion 350 to be described later may also display the topic items likewise. In this way, the user can easily access the high-interest contents. The “VIEW MORE” button 334 is a button to open so-called accordion display. In other words, the “VIEW MORE” button 334 is a button for expanding the area to display the topic items. In the case where the user presses the “VIEW MORE” button 334, the topic display portion 332 is expanded as in FIG. 4 to be described later, and all of the topic items that belong to the category “LIFE” are displayed therein.

The category display portion 340 is a display region concerning a category “WORK”. In the following, configurations of the category display portion 340 which are different from those of the category display portion 330 will be described. Explanations of the configurations which are the same as those of the category display portion 330 will be omitted. Note that the same applies to the category display portion 350 to be described later. The category display portion 340 is formed from a set of a category name portion 341 and a topic display portion 342. The category “WORK” is displayed in the category name portion 341. The topic display portion 342 includes topic items 343a to 343d and a “VIEW MORE” button 344. The topic items 343a to 343d are display items representing respective topics that belong to the category “WORK”.

The category display portion 350 is a display region concerning a category “STUDY”. The category display portion 350 is formed from a set of a category name portion 351 and a topic display portion 352. The category “STUDY” is displayed in the category name portion 351. The topic display portion 352 includes topic items 353a to 353d and a “VIEW MORE” button 354. The topic items 353a to 353d are display items representing respective topics that belong to the category “STUDY”.

As described above, the web browser according to the present embodiment displays the topic items, which correspond to the respective category display portions, in the respective category display portions. Thus, the multiple category display portions are displayed all at once, so that the user can understand the presence of the multiple categories simply and intuitively. At the same time, the user can simply and intuitively recognize the contents of the respective categories by seeing the topic items. In other words, it is possible to secure viewability of the web page. Meanwhile, it is possible to suppress degradation of visibility by restricting the number of display of the topic items corresponding to each category as small as four. The web browser according to the present embodiment separates modes of using the printer into multiple topics and categorizes the topics (into groups) for display. By displaying the topics as described above, the user can easily search for a topic that represents a mode of use suitable for the user or a mode of use beneficial for the user. Thus, it is possible to enhance the willingness of the user to purchase the printer or consumable supplies by the user, thus leading to an increase in sales of the printer or the consumable supplies.

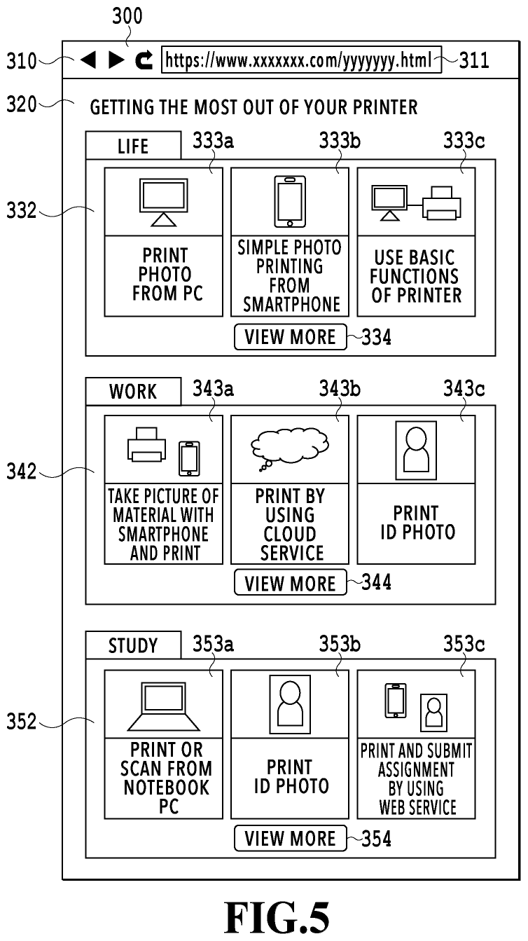

FIG. 4 is a diagram showing another example of the display screen 300 of the web page displayed on the web browser in a case where the window size is large. To be more precise, FIG. 4 shows the display screen 300 to be displayed on the web browser 201 in the case where the “VIEW MORE” button 334 in FIG. 3 is pressed by the user. Configurations different from those in FIG. 3 will be described with reference to FIG. 4. Explanations of the same configurations as those in FIG. 3 will be omitted. From now on, explanations of the same configurations as those discussed earlier will be omitted regarding FIGS. 5 to 8 as well.

The topic display portion 332 in FIG. 4 includes topic items 333a to 333j and a “CLOSE” button 335. In FIG. 4, the topic display portion 332 is expanded and all the topic items that belong to the category “LIFE” are displayed therein. That is to say, in the case where the “VIEW MORE” button 334 on the category display portion 330 in FIG. 3 is pressed by the user, the web browser 201 displays the topic items 333e to 333j that have not previously been displayed in FIG. 3. Thus, the user can visually recognize all the topics that belong to the category “LIFE”. Meanwhile, instead of the “VIEW MORE” button 334, the web browser 201 displays the “CLOSE” button 335 for restoring the expanded topic display portion 332 to its original state. The “CLOSE” button 335 is a button for closing the so-called accordion display. In the case where the “CLOSE” button 335 is pressed by the user, the web browser 201 restores the screen display in FIG. 4 to the screen display in FIG. 3. Along with the expansion of the topic display portion 332, the category display portions 340 and 350 are displayed while being shifted downward in an amount equivalent to the expansion of the topic display portion 332. In FIG. 4, the category display portions 340 and 350 remain in a state visually recognizable to the user even after the expansion of the topic display portion 332. However, the present disclosure is not limited to this configuration. For example, part or all of the category display portion 340 or 350 may be displayed in such a way as to be visually unrecognizable to the user along with the expansion of the topic display portion 332.

FIG. 5 is a diagram showing an example of the display screen 300 of the web page displayed on the web browser in a case where the window size is medium (a third size). To be more precise, FIG. 5 shows the display screen 300 to be displayed on the web browser in the case where the window size is set to “medium” as a consequence of reducing the window size from the state of display in FIG. 3. Configurations different from those in FIG. 3 will be described with reference to FIG. 5. Here, the medium window size means that the value of the window size is below the first threshold and equal to or above a second threshold.

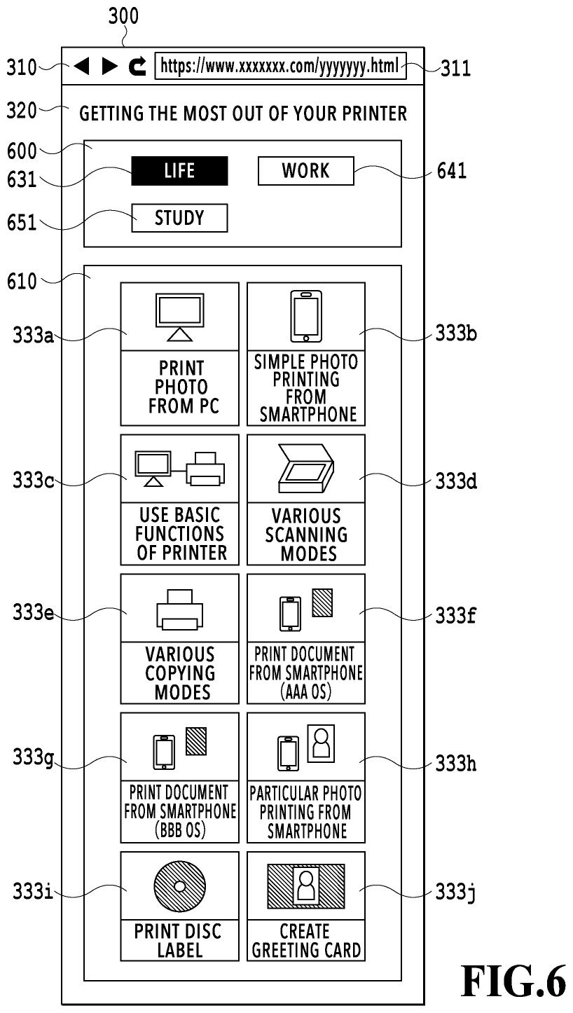

In FIG. 5, the topic display portion 332 includes the topic items 333a to 333c and the “VIEW MORE” button 334. The topic display portion 342 includes the topic items 343a to 343c and the “VIEW MORE” button 344. The topic display portion 352 includes the topic items 353a to 353c and the “VIEW MORE” button 354. That is to say, in FIG. 5, the number of topic items displayed in each topic display portion is equal to three (a second number). On the other hand, the number of topic items displayed in each topic display portion in FIG. 3 is equal to four (the first number). In other words, the topic items displayed in the respective topic display portions in FIG. 5 are less than those displayed in FIG. 3. As described above, the second number is less than the first number. In the case of reducing the window size, the visibility of the respective topic items may be deteriorated if the topic items are displayed without reducing the number of the topic items to be displayed in the respective topic display portions. In other words, since the topic items to be displayed therein are reduced in size, the visibility of the topics by the user may possibly be deteriorated. On the other hand, it is possible to display the respective topic items in a certain size or larger (equal to or above a predetermined size) by displaying the topic items less than the first number, thereby securing visibility of the topic items. At the same time, the web browser keeps on displaying the topic items, which correspond to the respective topic display portions, on the respective topic display portions. This makes it possible to secure viewability of the web page even in the case where the window size is reduced. The state of display transitions to a state in FIG. 6 to be described later in the case where the windows size is further reduced from this state to a “small” window size. The state of display transitions to the state of display in FIG. 3 in the case where the window size is increased to the “large” size by increasing the window size from the state in FIG. 5.

FIG. 6 is a diagram showing an example of the display screen 300 of the web page displayed on the web browser in a case where the window size is small (a second size). To be more precise, FIG. 6 shows the display screen 300 to be displayed on the web browser 201 in the case where the window size is set to “small” as a consequence of reducing the window size from the state of display in any of FIGS. 3 to 5. Configurations different from those in FIGS. 3 to 5 will be described with reference to FIG. 6. Here, the small window size means that the value of the window size is below the second threshold.

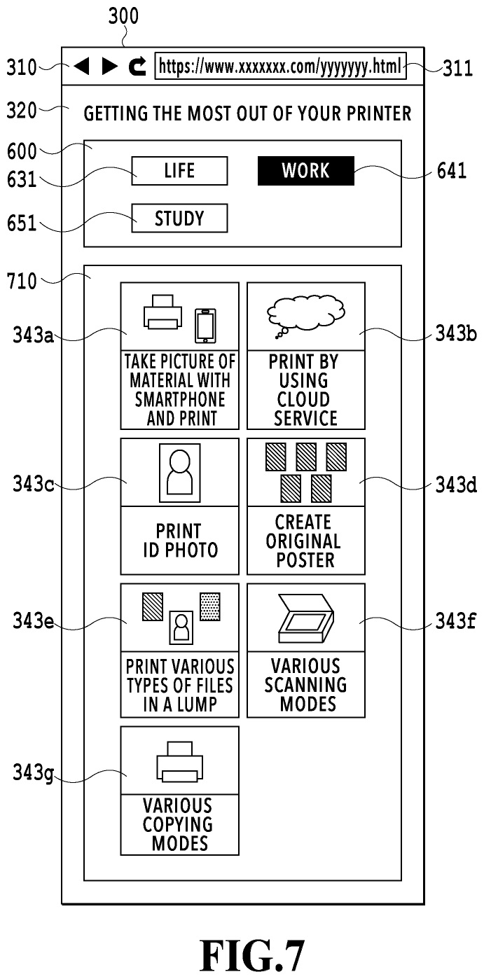

The display screen 300 in FIG. 6 has a layout that is significantly different from those in FIGS. 3 to 5. The contents display portion 320 in FIG. 6 includes a tab display portion 600 and a topic display portion 610. The tab display portion 600 includes a tab 631, a tab 641, and a tab 651. The tab 631 is an operation item corresponding to the category “LIFE”. The tab 641 is an operation item corresponding to the category “WORK”. The tab 651 is an operation item corresponding to the category “STUDY”. As mentioned above, the multiple tabs corresponding to the respective categories are displayed in the tab display portion 600. However, the present disclosure is not limited to this configuration. For example, the web browser 201 may display an operator for displaying a pull-down menu (a drop-down list) instead of the tab display in the tab display portion 600. Moreover, the web browser 201 may display a pull-down menu in which each menu item has the same function as each tab mentioned above in response to the user's operation of the operator. The topic display portion 610 is a display region for displaying the topics that belong to the category of the tab selected in the tab display portion 600. FIG. 6 shows the display screen 300 in the case of selecting the tab 631 corresponding to the category “LIFE”. As shown therein, the web browser 201 displays the display screen 300 in FIG. 6 in a state where the tab corresponding to the category displayed at an uppermost part is selected, in the state of display before the transition. In other words, the tab selected in the first place in FIG. 6 is the one corresponding to the category displayed at the uppermost part in the display region before the change (the state of display in any of FIGS. 3 to 5). However, the present disclosure is not limited to this configuration. For example, the web browser 201 may display the display screen 300 in FIG. 6 in the state where the tab corresponding to the category for which the “VIEW MORE” button has been pressed most recently is selected, in the state of display before the transition. In other words, the tab to be selected in the first place in FIG. 6 corresponds to the category in which the “VIEW MORE” button has been pressed most recently before the change. To be more precise, the state of display transitions to the state in FIG. 6 in the case where the window size becomes small from the state of display in which the “VIEW MORE” button in the category “LIFE” is pressed by the user as shown in FIG. 4. Accordingly, under a situation of display while switching a mode of display based on the window size, the user can access a high-interest topic easily by displaying the topics in accordance with the state of display before the transition, so that comfortableness of browsing the web page can be improved. The topic display portion 610 includes the topic items 333a to 333j. That is to say, all the topic items that belong to the category “LIFE” are displayed on the display screen 300 in FIG. 6. Although all the topic items that belong to the category corresponding to the tab are displayed in FIG. 6, the present disclosure is not limited to this configuration. For example, in the case where a vertical width of the window size is small, the web browser 201 may display part of the topic items instead of displaying all the topic items all at once. In this case, the web browser 201 may display such undisplayed topic items in accordance with a scroll operation by the user. Meanwhile, the topic items in FIG. 6 are displayed in the same size as the topic items in FIGS. 3 to 5 which are denoted by the same reference signs as the relevant topic items. Accordingly, it is possible to suppress deterioration of visibility of the respective topic items. Here, the topic items in FIG. 6 may be reduced in size to some extent in response to the reduction in size of the display screen 300. In this case, a lower limit size of each topic item is provided so as to keep each topic item from being displayed smaller than the lower limit size (a predetermined size) even in the case where the display screen 300 is reduced in size. In other words, each topic items is displayed in a size equal to or larger than a certain size. The topic items other than the category corresponding to the selected tab 631 are not displayed on the display screen 300 in FIG. 6. That is to say, in the case where the tab 631 corresponding to the category “LIFE” is selected, all the topic items that belong to the category “LIFE” are displayed. On the other hand, the topic items that belong to the category “WORK” or the category “STUDY” are not displayed. For example, the user selects the tab 641 in the case where the user wants to access a topic that belongs to the category “WORK” from the display screen 300 in FIG. 6. In the case where the tab 641 is selected, all the topic items that belong to the category “WORK” are displayed as in FIG. 7 to be described later. Meanwhile, in the case where the window size is increased through an operation by the user, the state of display in FIG. 6 transitions to any of the states of display in FIGS. 3 to 5. In this case, the web browser 201 may display the display screen 300 in the state where the “VIEW MORE” button corresponding to the category of the most recently selected tab in the state of display in FIG. 6 is pressed. To be more precise, in the case where the window size becomes large, the state of display in FIG. 6 transitions to the state of display after pressing the “VIEW MORE” of the category “LIFE” as shown in FIG. 4. In this way, it is possible to maintain the state of display before the transition in which all the topics are displayed under the situation of display while switching the mode of display based on the window size, so that deterioration of viewability of the topics associated with the change in window size can be suppressed. In the meantime, the web browser 201 may display the category corresponding to the most recently selected tab in the state of display in FIG. 6 at a display position that falls within a predetermined range in any of the display regions in FIGS. 3 to 6. For example, in the case where the window sizes becomes large from the state of display in FIG. 6, the category display portion 330 of the category “LIFE” is displayed in such a way as to fall within a region at an upper half of the display screen 300 as shown in FIG. 3. In this way, under the situation of display while switching the mode of display based on the window size, the category corresponding to the most recently selected tab before the transition is displayed at a position easily visible by the user. Thus, comfortableness of browsing the web page can be improved.

FIG. 7 is a diagram showing an example of the display screen 300 of the web page. To be more precise, the web browser displays this display screen 300 in the case where the tab 641 is selected in the state of display in FIG. 6 by the user. Different configurations from those in FIG. 6 will be described with reference to FIG. 7. A topic display portion 710 in FIG. 7 includes topic items 343a to 343g that belong to the category “WORK” corresponding to the tab 641. That is to say, in the case where the tab 641 is selected on the display screen 300 in FIG. 6, the web browser 201 displays the topic items 343a to 343g without displaying the topic items 333a to 333j. In this case, the user can visually recognize the topic items 343a to 343g that belong to the category “WORK” and access the topics concerning the “WORK”. The same applies to the topics that belong to the category “STUDY”.

As described above, the web browser displays the topic items that belong to the category corresponding to the selected tab in the topic display portion without displaying the topic items that belong to all the categories therein. Thus, it is possible to efficiently display the multiple topic items that belong to the multiple categories in the limited display region without deteriorating the visibility of the respective topic items.

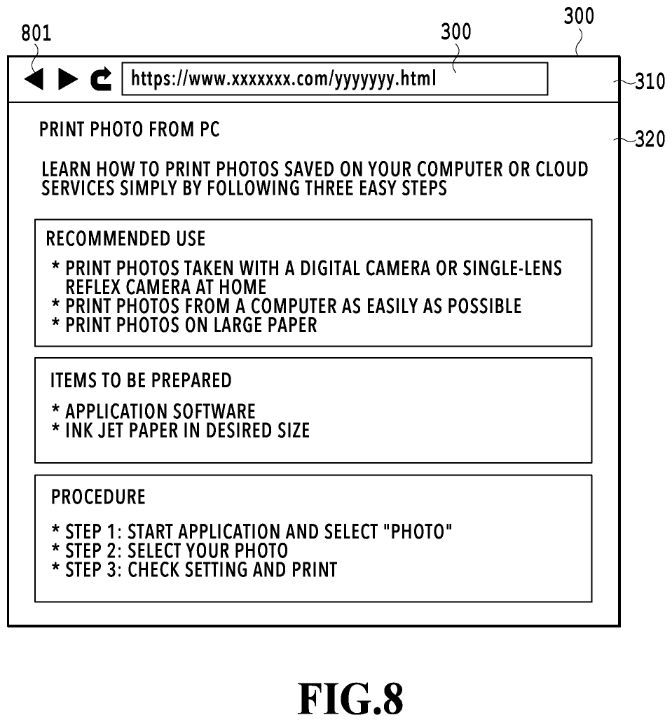

FIG. 8 is a diagram showing an example of the display screen of the web page. To be more precise, FIG. 8 shows the display screen 300 displayed on the web browser in the case where the topic item 333a is selected in any of FIGS. 3 to 6. The display screen 300 will be described with reference to FIG. 8. In the case where the user selects the topic item 333a, the web browser 201 accesses the URL corresponding to the topic item 333a and displays a screen as shown in FIG. 8, which describes details of the topic represented by the topic item 333a. As for the window size, the screen is displayed on the same size as any of FIGS. 3 to 6 before the transition to FIG. 8. In the case where a return button 801 on the browser is pressed by the user, the display screen returns to the display screen 300 in any of FIGS. 3 to 6 before the transition to FIG. 8.

FIG. 9 is a flowchart showing an example of the screen display processing by the web browser 201. To be more precise, FIG. 9 is a flowchart describing details of the processing in S217 in FIG. 2 to be executed by the CPU 101 as a function of the web browser. The details of the processing in S217 will be described with reference to FIG. 9. The processing by the web browser 201 in FIG. 9 is implemented by causing the CPU 101 to load the program 107 stored in the ROM 102 on the RAM 103, and to execute the loaded program. The CPU 101 executes respective steps described below based on a program of the web browser 201 and the obtained program 117. The flowchart in FIG. 9 is started by causing the web browser 201 to receive the response from the server 110 in S216. Note that the sign “S” in the explanations of the respective procedures described below means each procedure (each step) in FIG. 9.

In S900, the CPU 101 refers to a set value of an operating system (OS) as a function of the web browser 201, thereby obtaining the window size. A value of the window size represents pixels, for example. However, the present disclosure is not limited to the foregoing. For instance, the value of the window size may be a value (by inches) derived from resolution. Meanwhile, the user can freely change the window size by operating the mouse. Since the change in size of the window in response to the operation of the mouse by the user is a function of the OS, a value indicating the window size after the change is retained in the RAM 103 as the set value of the OS. In this case, in S900, the CPU 101 obtains the value indicating the window size after the change.

In S901, the CPU 101 determines whether or not the window size in the RAM 103 obtained in S900 is large. To be more precise, the CPU 101 determines whether or not the value of the window size is equal or above the first threshold. For example, the web browser 201 determines whether or not a transverse width of the window size is equal to or above 1024 pixels. The CPU 101 proceeds to processing in S902 in the case where the window size is determined to be large (Yes), or proceeds to processing in S903 in the case where it is determined to be not large (No).

In S902, the CPU 101 refers to a description concerning the layout of the web page described in the program 117 in the RAM 103 as a function of the web browser 201, and displays the web page (large layout) shown in FIG. 3 on the display device 104. Then, the CPU 101 proceeds to processing in S905.

In S903, the CPU 101 determines whether or not the window size in the RAM 103 obtained in S900 is medium. To be more precise, the CPU 101 determines whether or not the value of the window size is below the first threshold and equal or above the second threshold. For example, the CPU 101 determines whether or not the transverse width of the window size is below 1024 pixels and equal to or above 640 pixels. The CPU 101 proceeds to processing in S904 in the case where the window size is determined to be medium (Yes), or proceeds to processing in S910 in the case where it is determined to be not medium (No) (in a case where the window size is small).

In S904, the CPU 101 refers to the description concerning the layout of the web page described in the program 117 in the RAM 103 as the function of the web browser 201, and displays the web page (medium layout) shown in FIG. 5 on the display device 104. Then, the CPU 101 proceeds to processing in S905.

In S910, the CPU 101 refers to the description concerning the layout of the web page described in the program 117 in the RAM 103 as the function of the web browser 201, and displays the web page (small layout) shown in FIG. 6 on the display device 104. Then, the CPU 101 proceeds to processing in S911.

In S905, the CPU 101 determines whether or not the “VIEW MORE” button being displayed on the display device 104 is pressed by the operation by the user as a function of the web browser 201. The CPU 101 proceeds to processing in S906 in the case where the “VIEW MORE” button is determined to be pressed (Yes), or proceeds to processing in S907 in the case where it is determined to be not pressed (No).

In S906, the CPU 101 refers to the program 117 in the RAM 103 as the function of the web browser 201, and displays all the topic items that belong to the category corresponding to the topic display portion including the “VIEW MORE” button pressed by the user. To be more precise, in the case where the “VIEW MORE” button 334 is pressed by the user on the condition that the display screen 300 in FIG. 3 is displayed, the web browser 201 displays the display screen 300 as shown in FIG. 4 on the display device 104. Then, the CPU 101 proceeds to processing in S907.

In S907, the CPU 101 determines whether or not the “CLOSE” button being displayed on the display device 104 is pressed by the operation by the user as a function of the web browser 201. The CPU 101 proceeds to processing in S908 in the case where the “CLOSE” button is determined to be pressed (Yes), or proceeds to processing in S909 in the case where it is determined to be not pressed (No).

In S908, the CPU 101 refers to the program 117 in the RAM 103 as the function of the web browser 201, and displays a predetermined number of the topic items that belong to the category corresponding to the category display portion including the “CLOSE” button pressed in S907. In other words, the web browser 201 closes the accordion that belongs to the category corresponding to the category display portion including the pressed “CLOSE” button, and displays the predetermined number of the topic items. Here, the predetermined number is equal to four in the case where the web browser 201 executed S902 earlier than S908. On toe other hand, the predetermined number is equal to three in the case where the web browser 201 executed S904 earlier than S908. That is to say, after execution of S908, the web browser 201 displays the display screen 300 shown in FIG. 3 in the case where S902 was executed earlier than S908. The web browser 201 displays the display screen 300 shown in FIG. 4 in the case where S904 was executed earlier than S908. Thereafter, the CPU 101 proceeds to the processing in S909.

In S911, the CPU 101 determines whether or not a tab of an unselected category being displayed on the display device 104 is pressed by the operation by the user as a function of the web browser 201. The CPU 101 proceeds to processing in S912 in the case where the tab of the unselected category is determined to be pressed (Yes), or proceeds to the processing in S909 in the case where it is determined to be not pressed (No).

In S912, the CPU 101 refers to the program 117 in the RAM 103 as the function of the web browser 201, and displays all the topic items corresponding to the tab of the category pressed by the user. To be more precise, in the case where the tab 641 that belongs to the category “WORK” is pressed by the user on the condition that the display screen 300 in FIG. 6 is displayed, the web browser 201 displays the display screen 300 as shown in FIG. 7. Then, the CPU 101 proceeds to the processing in S909.

In S909, the CPU 101 determines whether or not any of the topic items displayed in the topic display portion being displayed on the display device 104 is selected by the operation by the user as a function of the web browser 201. The CPU 101 proceeds to processing in S913 in the case where any of the topic items is determined to be selected (Yes), or proceeds to processing in S915 in the case where it is determined to be not selected (No).

In S913, the CPU 101 requests the web page that describes details of the topic corresponding to the topic display portion from the server 110 as the function of the web browser 201. Here, a flow of processing from a point of request by the web browser 201 for the relevant web page from the server 110 to a point of reception of the relevant web page is the same as the flow of the processing from S211 to S213 in FIG. 2. The CPU 101 displays the web page received from the server 110 on the display device 104. Then, the CPU 101 proceeds to processing in S914.

In S914, the CPU 101 determines whether or not the return button being displayed on the display device 104 is pressed by the operation by the user as a function of the web browser 201. To be more precise, in the case where the display screen 300 in FIG. 8 is displayed, the CPU 101 determines whether or not the return button 801 is pressed. The CPU 101 proceeds to the processing in S900 again in the case where the return button is determined to be pressed (Yes), or proceeds to the processing in S914 again in the case where it is determined to be not pressed (No).

In S915, the CPU 101 determines whether or not the web page 116 is cancelled as a function of the web browser 201. Here, cancellation of the web page 116 means an act of input of URL of an outside web page (a web page not included in the present embodiment) to the web browser 201, or termination of the web browser 201 by pressing an end button (not shown) by the user. The CPU 101 terminates the processing in the case of determination that the web page 116 is cancelled (Yes), or proceeds to the processing in S900 again in the case of determination that the web page 116 is not cancelled (No).

Now, a description will be given of processing by the web browser 201 in the case where the window size is changed by the user. Detection of the change in window size is carried out by the operating system (OS: not shown) and is not therefore carried out by the program of the web browser 201. However, the web browser 201 regularly obtains the window size as the flow continues as shown in the flowchart in FIG. 9, and displays the web page while determining the obtained window size as described above. To be more precise, the window size is obtained again in S900 in the case where the web browser 201 determines that the web page 116 is not cancelled in S915 and in the case where the web browser 201 determines that the return button is pressed in S914. Thereafter, in the case where the window size is changed, the web browser 201 displays the web page 116 based on that window size. In other words, in the case where the window size is changed by control of the OS, the processing based on the changed window size is carried out by the web browser 201. As a consequence, in the web browser 201, the display of the layout of the web page (the display processing in S902, S904, and S910) is switched in accordance with the change in window size.

As described above, according to the present embodiment, in the case where the window size is large or medium, the web browser displays the representative topic items out of the topic items corresponding to the respective categories on the respective topic display portions as shown in FIG. 3 or 5. Thus, viewability of the web page can be secured. According to the present embodiment, in the case where the window size is small, the topic items that belong to the category corresponding to the selected category tab can be displayed in the predetermined size or larger as shown in FIGS. 6 and 7. In this way, even in the case where the display region is small, the user can easily find the topic that is categorized into the category that meets the need of the user without deteriorating visibility. Meanwhile, according to the present embodiment, the web browser displays the web page in accordance with the window size under the situation where the window size is changed. For example, in the case where the window size is reduced from the state of display in FIG. 3, the web browser displays the display screen shown in FIG. 5. In the case where the window size is reduced further, the web browser displays the display screen shown in FIG. 6. Even in the case where the window size is changed as described above, the web browser can display the web page such that the user can easily understand the categories and the topics so as to access the desired topic easily.

A storage medium storing program codes of software for implementing the functions of the above-described embodiment is supplied to a system and/or an apparatus. Thereafter, it is needless to say that an object of the present disclosure is also attained by causing a computer (or any of the CPU and a micro processing unit (MPU)) of the system and/or the apparatus to read the program codes stored in the storage medium and to execute the program codes. In this case, the program codes read out of the storage medium per se implement the functions of the above-described embodiment, and the storage medium storing the program codes constitutes the present disclosure. For example, a flexible disk, a hard disk, an optical disk, a magneto-optical disk, a compact disc (CD)-ROM, a CD-R, and the like can be used as the storage medium for supplying the program codes. Meanwhile, a magnetic tape, a nonvolatile memory card, a ROM, a digital versatile disk (DVD), and the like can be used as the storage medium for supplying the program codes.

In the meantime, the functions of the above-described embodiment are realized by executing the program codes read out by a computer. Based on instructions of the program codes, the OS operating on the computer and the like conducts part of all of actual processing. Needless to say, the case of realizing the functions of the above-described embodiment by the processing is also included in the present disclosure.

Moreover, the program codes read out of the storage medium are written into a function expansion board inserted into the computer and/or a memory included in a function expansion unit connected to the computer. Thereafter, based on instructions of the program codes, the CPU or the like included in any of the function expansion board and the function expansion unit conducts part of all of actual processing. Needless to say, the case of realizing the functions of the above-described embodiment by the processing is also included in the present disclosure.

In addition, the supply of the program codes to the information processing apparatus can also be realized by using a communication measure such as a local area network (LAN) and/or an exclusive line besides the Internet.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, contents that are categorized into multiple categories can be displayed more preferably and visibly in accordance with a size of a display region.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-110580, filed Jul. 5, 2023, which is hereby incorporated by reference wherein in its entirety.

What is claimed is:

1. A non-transitory computer-readable storage medium storing a program for causing a computer to perform:
obtainment of information indicating a size of a size-changeable display region; and
control based on the obtained information such that
in a case where the size of the display region is a first size, display items that correspond to a first number being plural of contents and are categorized into a plurality of corresponding categories are displayed in a plurality of areas corresponding to the categories, respectively, in the display region, and
in a case where the size of the display region is a second size being smaller than the first size, a plurality of operation items corresponding to the plurality of categories, respectively, are displayed in the display region and a display item corresponding to the content categorized into the category corresponding to a selected one of the operation items is displayed without displaying a display item corresponding to the content categorized into the category corresponding to an unselected one of the operation items.

2. The non-transitory computer-readable storage medium according to claim 1, wherein
the first number is equal to or above 2.

3. The non-transitory computer-readable storage medium according to claim 1, wherein
control is performed such that, in a case where the size of the display region is a third size being smaller than the first size and larger than the second size, display items that correspond to a second number of the contents being less than the first number and are categorized into the corresponding categories are displayed in the plurality of areas corresponding to the plurality of categories, respectively.

4. The non-transitory computer-readable storage medium according to claim 1, wherein
control is performed such that each of the display items is displayed in a predetermined size or larger even in a case where the size of the display region is reduced from the first size to the second size.

5. The non-transitory computer-readable storage medium according to claim 1, wherein
each of the contents categorized into the plurality of categories is a content concerning a mode of using an apparatus.

6. The non-transitory computer-readable storage medium according to claim 5, wherein
the apparatus is a printing apparatus.

7. The non-transitory computer-readable storage medium according to claim 1, wherein
the plurality of categories at least include one of categories each concerning any of life, work, and study.

8. The non-transitory computer-readable storage medium according to claim 1, wherein
the first number of the contents are selected in descending order of a statistical number of times that the display items are selected by a user.

9. The non-transitory computer-readable storage medium according to claim 1, wherein
a tab to be firstly selected in a case of a change in size of the display region from the first size to the second size corresponds to a category displayed at an uppermost part in the display region before the change.

10. The non-transitory computer-readable storage medium according to claim 1, wherein
an operation item out of the plurality of operation items to be firstly selected in a case of a change in size of the display region from the first size to the second size corresponds to a category for which an operator for expanding an area to display the display item is operated most recently before the change.

11. The non-transitory computer-readable storage medium according to claim 1, wherein
in a case of a change in size of the display region from the second size to the first size, control is performed such that the display item of a category corresponding to an operation item selected before the change out of the plurality of operation items is displayed in a state of display being equivalent to a state of display in a case of operating an operator for expanding an area to display the display item.

12. The non-transitory computer-readable storage medium according to claim 1, wherein
in a case of a change in size of the display region from the second size to the first size, control is performed such that the display item corresponding to the content categorized into a category corresponding to an operation item selected before the change out of the plurality of operation items is displayed at a display position that falls within a predetermined range in the display region.

13. The non-transitory computer-readable storage medium according to claim 1, wherein
the plurality of operation items are any of a plurality of tabs and respective items in a pull-down menu.

14. A non-transitory computer-readable storage medium storing a program for causing a computer to perform:
obtainment of information indicating a size of a size-changeable display region; and
control based on the obtained information such that, in a case where the size of the display region is a first size, display items that correspond to a first number being plural of contents and are categorized into a plurality of corresponding categories are displayed in a plurality of areas corresponding to the categories, respectively, in the display region, wherein
each of the contents categorized into the plurality of categories is a content concerning a mode of using an apparatus, and
the plurality of categories at least include one of categories each concerning any of life, work, and study.

15. An information processing apparatus comprising:
at least one memory and at least one processor which function as
an obtaining unit to obtain information indicating a size of a size-changeable display region; and
a display control unit to perform control based on the obtained information such that
in a case where the size of the display region is a first size, display items that correspond to a first number being plural of contents and are categorized into a plurality of corresponding categories are displayed in a plurality of areas corresponding to the categories, respectively, in the display region, and
in a case where the size of the display region is a second size being smaller than the first size, a plurality of operation items corresponding to the plurality of categories, respectively, are displayed in the display region and a display item corresponding to the content categorized into the category corresponding to a selected one of the operation items is displayed without displaying a display item corresponding to the content categorized into the category corresponding to an unselected one of the operation items.

16. An information processing method comprising the steps of:
obtaining information indicating a size of a size-changeable display region; and
performing control based on the obtained information such that
in a case where the size of the display region is a first size, display items that correspond to a first number being plural of contents and are categorized into a plurality of corresponding categories are displayed in a plurality of areas corresponding to the categories, respectively, in the display region, and
in a case where the size of the display region is a second size being smaller than the first size, a plurality of operation items corresponding to the plurality of categories, respectively, are displayed in the display region and a display item corresponding to the content categorized into the category corresponding to a selected one of the operation items is displayed without displaying a display item corresponding to the content categorized into the category corresponding to an unselected one of the operation items.
